(19) United States
(12) Patent Application Publication
(10) Pub. No.: US 2022/0357026 A1
(43) Pub. Date: Nov. 10, 2022

(54) Floor Lamp Capable Of Rotating By 360 Degrees

(71) Applicant: Dongguan Xingdian Lighting Accessories Co., Ltd., Guangdong Province (CN)

(72) Inventor: Pei Cheng Zhang, Dongguan City (CN)

(21) Appl. No.: 17/709,191

(22) Filed: Mar. 30, 2022

(30) Foreign Application Priority Data
May 10, 2021 (CN) 202120986089 .9

(51) Int. Cl. F21V 23/06; F21V 21/02; F21V 21/10; H01R 13/631

(52) U.S. Cl. CPC F21V 23/06; F21V 21/02; F21V 21/10; H01R 13/631

(57) ABSTRACT

The present invention discloses a floor lamp capable of rotating by 360 degrees, comprising a power controller, a base, a support rod, an upper lamp tube, a lower lamp tube and a connecting part. The upper lamp tube and the lower lamp tube are connected through the connecting part; the upper lamp tube and the lower lamp tube can rotate at any adjusted angle by taking the connecting part and a power conductive connector on the base as axes; and the light is irradiated to any angle through the upper lamp tube and a hollow window of a lamp tube shell of the lower lamp tube, and is stable and reliable.

### TECHNICAL FIELD

The present invention relates to a lighting fixture, and in particular to a floor lamp capable of rotating by 360 degrees.

### BACKGROUND

At present, because the floor lamp on the market has large volume and heavy weight, the illumination angles of most lamp tubes cannot be rotated and adjusted. Thus, there is no good method to solve the problem when a user does not want the light to shine directly on a human body. Although some floor lamps can be rotated and adjusted, lamp caps are mainly rotated, and cannot be rotated by 360 degrees. Because power connection lines on the lamp caps are twisted for a long time, wires may be twisted off and bring broken circuit or short circuit, thereby seriously affecting the use function of the floor lamps.

### SUMMARY

The purpose of the present invention is to solve the above defects to provide a floor lamp capable of rotating by 360 degrees, with portability and safe and reliable use.

The purpose of the present invention is realized by the following mode:

A floor lamp capable of rotating by 360 degrees comprises a power controller, a base, a support rod and a luminous body; the luminous body comprises an upper lamp tube, a lower lamp tube and a connecting part; the upper lamp tube and the lower lamp tube are connected through the connecting part; the connecting part comprises an upper conductive connector, a lower conductive connector, a connecting wire and a hollow connecting pipe; the upper conductive connector and the lower conductive connector are respectively fixed at both ends of the connecting pipe; the connecting wire penetrates through the hollow part of the connecting pipe to electrically connect the upper conductive connector and the lower conductive connector; the lower lamp tube comprises a lamp tube shell, a light diffusion cover, a light-emitting lamp bar and two conductive sockets; the two conductive sockets are electrically connected with both ends of the light-emitting lamp bar respectively; the light-emitting lamp bar is fixed in the light diffusion cover; the light diffusion cover fixed with the light-emitting lamp bar is inserted into the lamp tube shell together with the two conductive sockets; and the two conductive sockets are located at both ends of the lamp tube shell.

In the above description, as a preferred solution, the upper conductive connector and the lower conductive connector are provided with more than two conductive rings and more than one insulating ring, and the upper conductive connector and the lower conductive connector have cylindrical shapes.

In the above description, as a preferred solution, each conductive socket comprises a conductive socket female head, a fixing plate, a conductive socket shell, a conductive socket cover and a V-shaped metal sheet; one end of the V-shaped metal sheet is provided with a circular hole; the surface of the conductive socket shell is provided with a groove and a positioning column; the conductive socket female head is fixed on the fixing plate; the fixing plate is fixed in the conductive socket cover; the conductive socket cover and the conductive socket shell are closely matched and covered; the circular hole on the V-shaped metal sheet is inserted into the positioning column on the conductive socket shell; and the other end is put into the groove on the surface of the conductive socket shell.

In the above description, as a preferred solution, the upper lamp tube comprises an upper lamp tube cap, and the upper lamp tube cap is covered on the other end of the lamp tube shell.

In the above description, as a preferred solution, the base comprises a chassis, a bottom cover and a base screw; a through hole is formed at the middle position of the chassis; the support rod is a hollow structure which has a screw hole at the bottom, a power plug at the top and power holes at the side; the base screw is used to fix the support rod to one side of the chassis through the through hole in the chassis; the bottom cover is bonded to the other side of the chassis; both ends of the power controller are connected with a power line; and one end of the power line is connected to the power plug on the support rod through the power holes on the side surface of the support rod.

In the above description, as a preferred solution, the power plug comprises a power conductive connector and a welding head; the power conductive connector has a cylindrical shape; and the power conductive connector has more than two conductive rings and more than one insulating ring.

In the above description, as a preferred solution, the lamp tube shell is provided with a strip-shaped hollow window.

The present invention has the following beneficial effects: the upper lamp tube and the conductive sockets in the lower lamp tube are connected with the upper conductive connector and the lower conductive connector of the connecting part. Because the conductive connectors adopt cylindrical design and the conductive connectors are provided with the conductive rings, the conductive connectors can be rotated at any angle after being inserted into jacks of the conductive sockets and normal use of the upper lamp tube and the lower lamp tube can be ensured.

### DESCRIPTION OF DRAWINGS

The present invention is further described below in combination with the drawings and embodiments.

FIG. 1 is a stereographic structural schematic diagram of an embodiment of the present invention at an elevation angle;

FIG. 2 is a stereographic structural exploded schematic diagram of an embodiment of the present invention at an elevation angle;

FIG. 3 is a stereographic structural exploded schematic diagram of a connecting part in an embodiment of the present invention;

FIG. 4 is a stereographic structural exploded schematic diagram of a support rod and a base in an embodiment of the present invention;

FIG. 5 is a stereographic structural exploded schematic diagram of an upper lamp tube in an embodiment of the present invention;

FIG. 6 is a stereographic structural exploded schematic diagram of a conductive socket in an embodiment of the present invention;

FIG. 7 is a stereographic structural schematic diagram of a power plug in an embodiment of the present invention; and

FIG. 8 is a stereographic structural exploded schematic diagram of a lower lamp tube in an embodiment of the present invention.

In the figures, 1 upper lamp tube; 2 lower lamp tube; 3 connecting part; 4 power controller; 5 support rod; 6 base; 7 chassis; 8 base screw; 9 bottom cover; 10 power plug; 11 power hole; 12 connecting pipe; 13 upper conductive connector; 14 lower conductive connector; 15 lamp tube shell; 16 light diffusion cover; 17 light-emitting lamp bar; 18 upper lamp tube cap; 19 conductive socket; 20 V-shaped metal sheet; 21 conductive socket shell; 22 conductive socket female head; 23 fixing plate; 24 conductive socket cover; 25 power conductive connector; 26 welding head; 27 insulating ring of power conductive connector; 28 conductive ring of power conductive connector.

### DETAILED DESCRIPTION

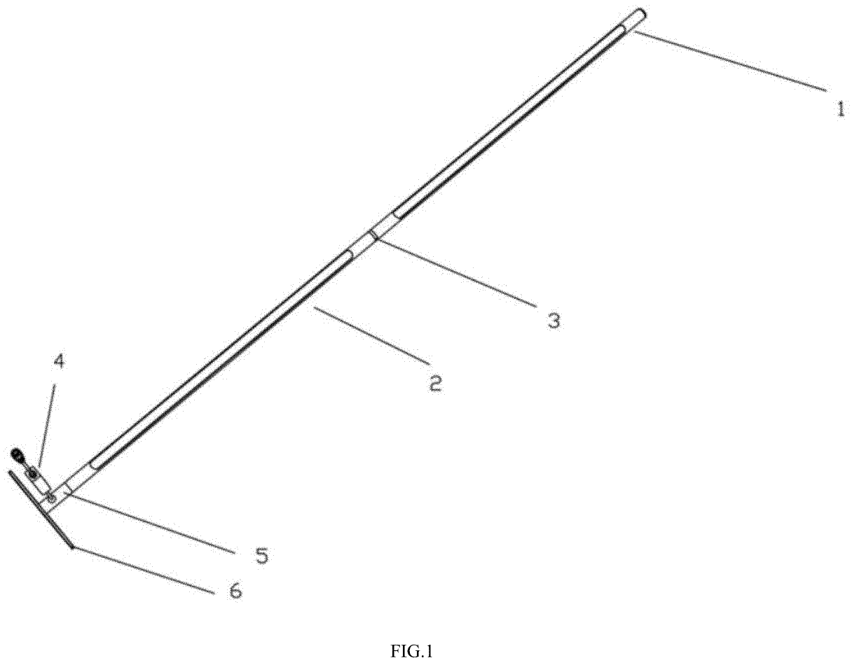

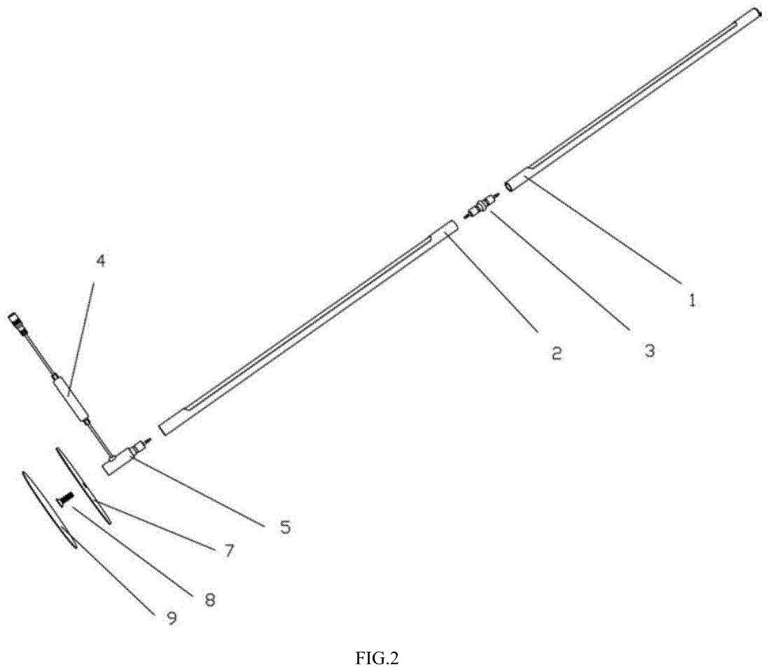

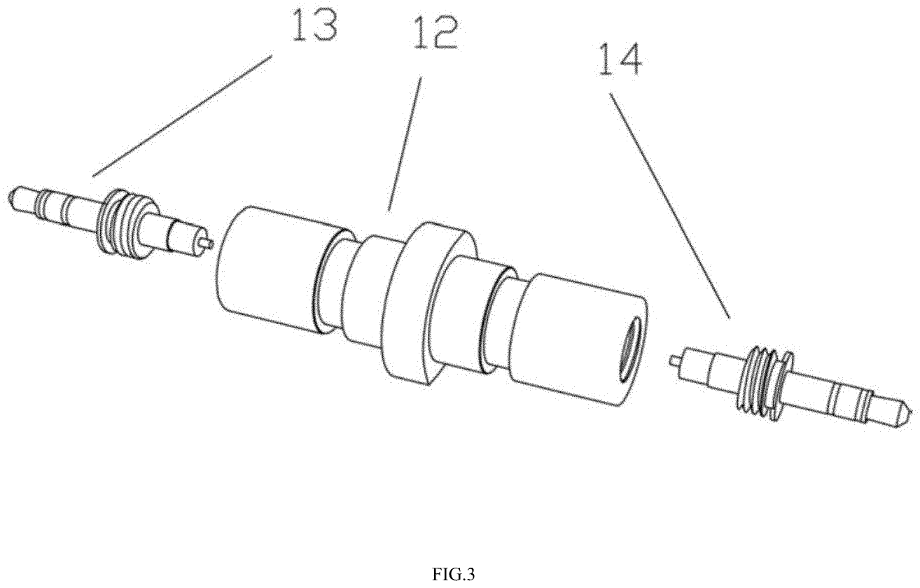

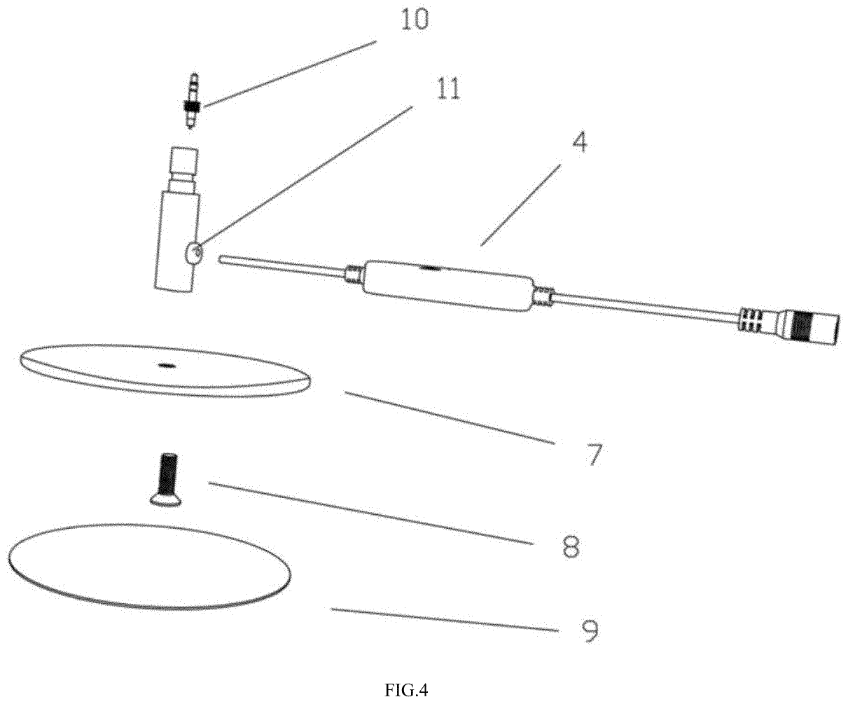

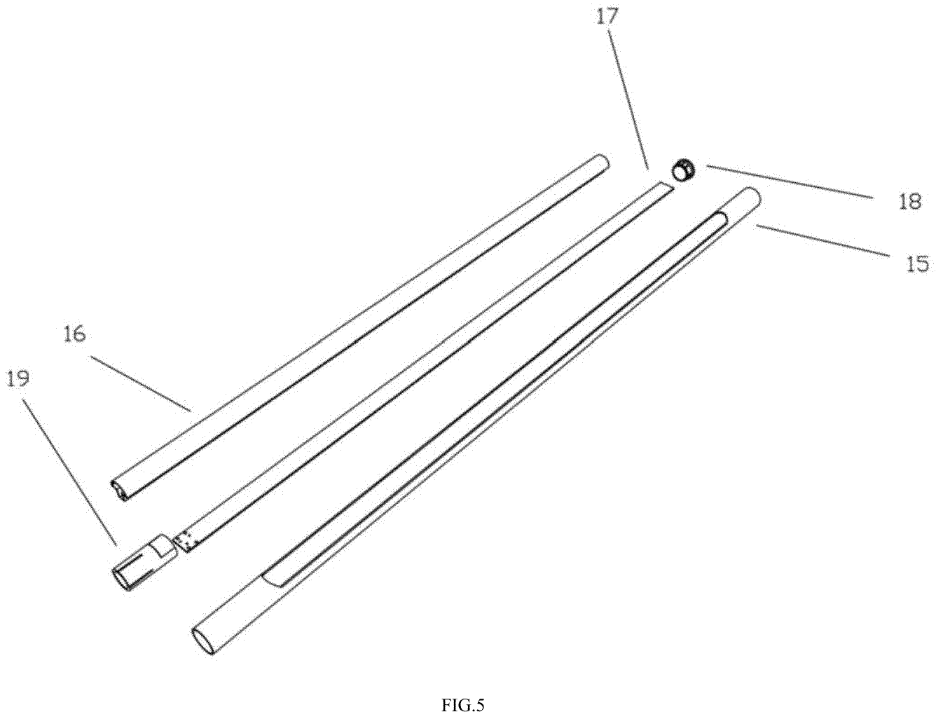

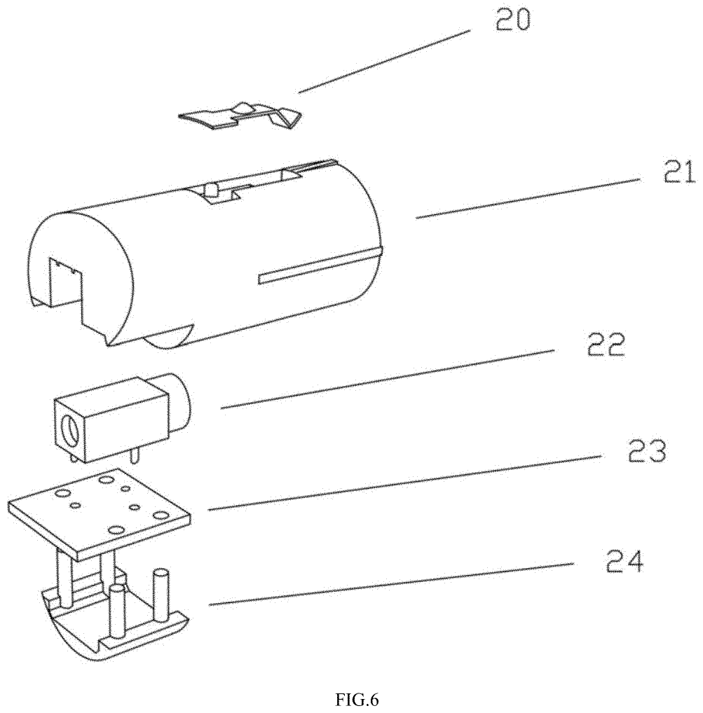

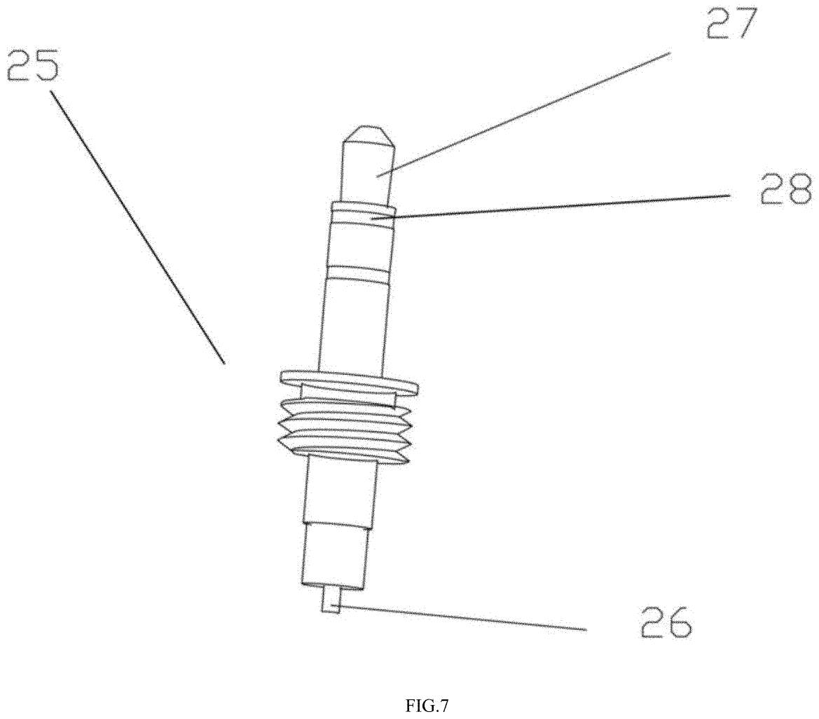

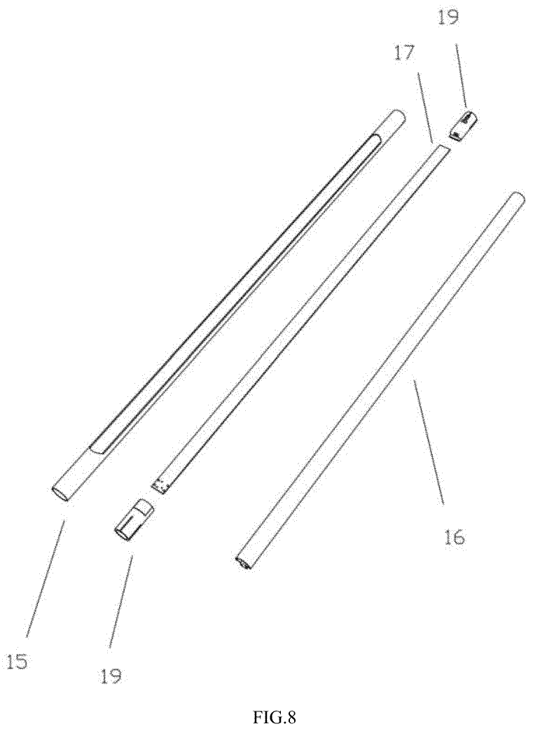

In the present embodiment, by referring to FIG. 1 to FIG. 8, a floor lamp capable of rotating by 360 degrees comprises a power controller 4, a base 6, a support rod 5, an upper lamp tube 1, a lower lamp tube 2 and a connecting part 3. The upper lamp tube 1 and the lower lamp tube 2 are connected through the connecting part 3. The base 6 comprises a chassis 7, a bottom cover 9 and a base screw 8; a through hole is formed at the middle position of the chassis 7; the support rod 5 is a hollow structure which has a screw hole at the bottom; the base screw 8 is inserted into the screw hole at the bottom of the support rod 5 through the through hole in the middle of the chassis 7, and is tightened to fix the support rod 5 to the chassis 7. Then, the bottom cover 9 is bonded to the back surface of the chassis 7 through an adhesive. Both ends of the power controller 4 are connected with a power line; one end of the power line penetrates through the hollow position in the support rod 5 through the power holes 11 on the side surface of the support rod 5, and is welded onto a welding head 26 of a power plug 10 on the support rod 5; and then, the power plug 10 is screwed in the other end of the support rod 5.

The upper conductive connector 13 and the lower conductive connector 14 are respectively fixed on both ends of a connecting pipe 12; and a connecting wire penetrates through the hollow part of the connecting pipe 12 to electrically connect the upper conductive connector 13 and the lower conductive connector 14.

The lower lamp tube comprises a lamp tube shell 15, a light diffusion cover 16, a light-emitting lamp bar 17 and two conductive sockets 19. The light-emitting lamp bar 17 is composed of a strip-shaped circuit board and LED lamp beads; the LED lamp beads are welded on the strip-shaped circuit board; one end of the strip-shaped circuit board is welded with a conductive socket female head 22; the jack of the conductive socket female head 22 is circular structure; and then a conductive socket cover 24 is covered on the conductive socket female head 22, and the assembled light-emitting lamp bar 17, the conductive socket female head 22 and the conductive socket cover 24 are jointly buckled into a conductive socket shell 21. Then, the light-emitting lamp bar 17 is inserted into the hollow light diffusion cover 16; another conductive socket female head 22 is fixed to the fixing plate 23; the fixing plate 23 is fixed into the conductive socket cover 24; and the conductive socket cover 24 and the conductive socket shell 21 are closely matched and covered. A circular hole at one end of the V-shaped metal sheet 20 is inserted into a positioning column of the conductive socket shell 21, and the other end of the V-shaped metal sheet 20 is fixed into a groove corresponding to the conductive socket shell 21 to play a role of stably connecting the lower lamp tube 2 and the lower conductive connector 14. The conductive socket 19 and the circuit board of the light-emitting lamp bar 17 are welded together by a wire and the conductive socket 19 is inserted into the other end of the lamp tube shell 15. The assembly of the lower lamp tube 2 is completed. One end of the assembled lower lamp tube 2 is inserted into the power plug 10. A metal shrapnel is arranged in the conductive socket female head 22 of the lower lamp tube 2, and is electrically connected with a conductive ring 28 of a power conductive connector on the power conductive connector 25. The other end of the lower lamp tube 2 is inserted into one end of the connecting part 3; the metal shrapnel in another conductive socket female head 22 of the lower lamp tube 2 is electrically connected with the conductive ring 28 of the power conductive connector on the lower conductive connector 14 of the connecting pipe 3; and an insulating ring 27 of the power conductive connector plays a role of isolating the conductive ring to prevent short circuit.

The upper lamp tube 1 comprises a light diffusion cover 16, a light-emitting lamp bar 17 and a conductive socket 19. The installation mode of the upper lamp tube 1 is similar to the installation mode of the lower lamp tube 2, but only one conductive socket 19 is installed. After the upper lamp tube 1 is completed, the top end of the upper lamp tube 1 is covered with a lamp tube cap 18 and the other end is inserted into one end of the connecting part 3 to form a complete floor lamp. The two lamp tubes of the floor lamp can be manually and adjustably rotated by taking the connecting part 3 and the power plug 10 on the base 6 as axes. Because the upper conductive connector 13, the lower conductive connector 14 and the power conductive connector 25 have cylindrical shapes, rotation at any angle does not affect a rotation function and energizing performance, and independent rotation at any angle can be realized. The light is irradiated to any angle through a hollow window of the lamp tube shell 15, and is stable and reliable.

The above contents are further detailed descriptions of the present invention in combination with specific preferred embodiments. However, it cannot be considered that the concrete implementation of the present invention is only limited to these descriptions. For those ordinary skilled in the art to which the present invention belongs, several simple deductions or replacements may be made without departing from the conception of the present invention, all of which shall be considered to belong to the protection scope of the present invention.

1. A floor lamp capable of rotating by 360 degrees, comprising a power controller, a base, a support rod and a luminous body, wherein the luminous body comprises an upper lamp tube, a lower lamp tube and a connecting part; the upper lamp tube and the lower lamp tube are connected through the connecting part; the connecting part comprises an upper conductive connector, a lower conductive connector, a connecting wire and a hollow connecting pipe; the upper conductive connector and the lower conductive connector are respectively fixed at both ends of the connecting pipe; the connecting wire penetrates through the hollow part of the connecting pipe to electrically connect the upper conductive connector and the lower conductive connector; the lower lamp tube comprises a lamp tube shell, a light diffusion cover, a light-emitting lamp bar and two conductive sockets; the two conductive sockets are electrically connected with both ends of the light-emitting lamp bar respectively; the light-emitting lamp bar is fixed in the light diffusion cover; the light diffusion cover fixed with the light-emitting lamp bar is inserted into the lamp tube shell together with the two conductive sockets; and the two conductive sockets are located at both ends of the lamp tube shell.

2. The floor lamp capable of rotating by 360 degrees according to claim 1, wherein the upper conductive connector and the lower conductive connector are provided with more than two conductive rings and more than one insulating ring, and the upper conductive connector and the lower conductive connector have cylindrical shapes.

3. The floor lamp capable of rotating by 360 degrees according to claim 1, wherein each conductive socket comprises a conductive socket female head, a fixing plate, a conductive socket shell, a conductive socket cover and a V-shaped metal sheet; one end of the V-shaped metal sheet is provided with a circular hole; the surface of the conductive socket shell is provided with a groove and a positioning column; the conductive socket female head is fixed on the fixing plate; the fixing plate is fixed in the conductive socket cover; the conductive socket cover and the conductive socket shell are closely matched and covered; the circular hole on the V-shaped metal sheet is inserted into the positioning column on the conductive socket shell; and
the other end is put into the groove on the surface of the conductive socket shell.

4. The floor lamp capable of rotating by 360 degrees according to claim 1, wherein the upper lamp tube comprises an upper lamp tube cap, and the upper lamp tube cap is covered on the top end of the upper lamp tube.

5. The floor lamp capable of rotating by 360 degrees according to claim 1, wherein the base comprises a chassis, a bottom cover and a base screw; a through hole is formed at the middle position of the chassis; the support rod is a hollow structure which has a screw hole at the bottom, a power plug at the top and power holes at the side; the screw is used to fix the support rod to one side of the chassis through the through hole in the chassis; the bottom cover is bonded to the other side of the chassis; both ends of the power controller are connected with a power line; and one end of the power line is connected to the power plug on the support rod through the power holes on the side surface of the support rod.

6. The floor lamp capable of rotating by 360 degrees according to claim 5, wherein the power plug comprises a power conductive connector and a welding head; the power conductive connector has a cylindrical shape; and the power conductive connector has more than two conductive rings and more than one insulating ring.

7. The floor lamp capable of rotating by 360 degrees according to claim 1, wherein the lamp tube shell is provided with a strip-shaped hollow window.
